(19) United States
(12) Patent Application Publication
(10) Pub. No.: US 2011/0070571 A1
(43) Pub. Date: Mar. 24, 2011

(54) METHOD AND SYSTEMS FOR IMPROVING FERTILITY

(76) Inventor: Joanne Gosselin Verkuilen, Montclair, NJ (US)

(21) Appl. No.: 12/843,975

(22) Filed: Jul. 27, 2010

Related U.S. Application Data
(60) Provisional application No. 61/271,926, filed on Jul. 28, 2009.

(51) Int. Cl. G09B 5/00

(52) U.S. Cl. 434/308

(57) ABSTRACT

The present invention provides audio and audio-visual programming to assist women in improving fertility and chance of conception through a multi-faceted regimen designed for daily usage over a usage period that corresponds to the female reproductive system. The regimen utilizes the following: (i) stress reduction through auditory progressive body scanning, deep breathing and visualization of events that would intend to induce deep mental and physical relaxation; (ii) physiologically-based detailed guided visualization of what the reproductive cycle is accomplishing in that particular time of the cycle; and (iii) cognitive restructuring through reduction of negative thought patterns to improve emotional state and well-being.

### CROSS-REFERENCE TO RELATED APPLICATIONS

This application claims the benefit of the following commonly owned U.S. Provisional Patent Application, which is incorporated herein by reference in its entirety: App. No. 61/271,926 filed on Jul. 28, 2009 and entitled “Method and Systems for Improving Fertility.”

### FIELD OF THE INVENTION

This application describes a process, system and method to improve fertility in women by reducing levels of stress, visualizing specific physiological reproductive changes, and addressing negative thought patterns through an auditory and/or audio-visual regimen that corresponds to the female reproduction system where each program is designed to be used on a daily basis.

### BACKGROUND

The invention is based in part on medical and scientific literature that has made the following assertions: (i) stress and its negative effects on fertility and ovulation; (ii) the mind/body connection and the ability to use visualization exercises to manifest changes in the body, and (iii) the effects emotions, including depression, anxiety or other neurobiological conditions, may have in increasing infertility.

The Stress and Fertility Link. Stress negatively impacts fertility. It is also known that stress is compounded when women try to conceive month after month, creating a downward spiral that is difficult to break. Recent studies prove the negative impact stress has on the female reproductive cycle. The following is a summary of a few of the conclusions these studies have found:

Stress leads to reduced levels of hormones crucial for ovulation.

Women who underwent cognitive behavioral therapy showed a higher probability of having ovulation restored as compared to women who did not go through this therapy.

Women who did not ovulate in certain studies had excessive levels of cortisol, a stress hormone, in the brain fluid.

Women who went through relaxation training for infertility had much higher pregnancy rates than others who did not go through such training.

In a study with women undergoing donor sperm insemination, those with higher levels of anxiety prior to undergoing inseminations took significantly longer to conceive.

Women who were not stressed and/or depressed before starting IVF treatment had a conception rate twice as high as women who were stressed and/or depressed before treatment.

Research has shown that women undergoing treatment for infertility have a similar, and often higher, level of stress as women dealing with life-threatening illnesses such as cancer and heart disease. In addition, they report “infertile couples experience chronic stress each month, first hoping that they will conceive and then dealing with the disappointment if they do not. When diagnosed with infertility, many couples may no longer feel in control of their bodies or their life plan. Infertility can be a major crisis because of the important life goal of parenthood is threatened.

Women who are training extensively for athletic events show higher rates of anovulation, or a complete suppression of ovulation.

It is known that there is a specific part of the brain called the hypothalamus that monitors levels of stress and provides a key reproductive hormone called gonadotropin hormone, or otherwise known as GNRH. The hypothalamus is approximately the size of a walnut located in the middle of the brain. If there are high levels of stress that the hypothalamus is interacting with by emitting cortisol, the flow of GNRH may be impacted and therefore have the effect of reduced fertility.

Mind/Body Science. Mind/Body science is a developing area of medicine that is currently being researched by a variety of institutions and well-regarded medical professionals. One of first to studies indicating the effects of thought patterns on patients was related to heart rate and elevated blood pressure. By establishing a model for stress-induced hypertension, the study involved training squirrel monkeys to either raise or lower blood pressure using operant conditioning technology. The studies proved that the monkeys who were rewarded for higher blood pressure went on to develop hypertension, basically due to their own behaviors. Another study involved determining the effects on the body chemistry while in meditation. The studies determined that meditation, which is a simple act of changing thought patterns, decreased metabolism, rate of breathing and heart rate, and had slower brain waves.

Other scientists in the field researched the specific inter-workings between the mind and the body at the molecular level. Identifying certain receptors that are found on the surface of cells along with the ligands that interact with those receptors, they found that there is a physiological basis for mind and body communication. They compared the receptor sites to key-holes and ligands as the key and once connected, the door can be unlocked and a variety of changes can happen directly to that specific cell, such as cell division, mutation, etc. Most ligands are either peptides, neurotransmitters or steroids (testosterone, estrogen, progesterone, etc.). The peptides are typically sourced from areas in the brain commonly known to be influenced by our emotional state. Just as important as this discovery, however, was the understanding that the peptides were not just coming from areas of the brain as once previously thought. Peptides were found being produced in areas of the body that were surprising to most of the scientists. Such peptides were then influencing the brain in a feedback loop. In other words, they discovered the mechanism for how the mind and the body communicate back and forth constantly providing information where thoughts, emotions, levels of stress all play a central role in the flow of communication or peptides throughout the body.

Another study looked at the immune system and the fact that it could also be consciously controlled. Using different self-directed modalities on different groups such as self-hypnosis, biofeedback, and guided imagery, subjects were able to consciously increase the stickiness of their white blood cells, as measured by salvia and blood tests. This study was the first to show that psychological factors, or conscious direction through thought could directly affect cellular function in the immune system.

Practitioners of mind/body science utilize different methods or regimens for their patients, such as, meditation, deep breathing exercises, biofeedback, cognitive restructuring, and guided visualizations. The last, guided visualizations, is a process by which the subject gets into a relaxed but conscious state and is guided through words by a practitioner, or on their own, to visualize a certain body part, function, or process. Once that is held in the minds eye, it is then instructed to perform an act, change or modify itself in some way. It is known that through visualization a subject can increase the blood flow into a body part and thereby increase the availability of oxygen and nutrients to carry away toxins and nourish the cells. There is really no limit to the body function or what the visualization is. It can go as small as on the molecular level, or as large as the entire body. It is known that an understanding of the physiology before hand—or an education thereof—would enable a subject to better consciously intervene and intentionally change the body part or process.

Addressing and Releasing Emotional Issues. It has been proven that women who are undergoing treatments for infertility have as much stress and anxiety as others who are experiencing life threatening diseases such as cancer or heart disease. The uncertainty of not being able to have children throws into question one's life plan, creating unparalleled levels of anxiety and stress. It has been documented that emotions interplay directly with the functioning of our bodies. Women experiencing infertility may have not only emotional issues before the question of conception, but with the added enormity of dealing with the infertility crisis as well.

Unconscious thoughts, repressed anger or other deep-seated negative memories can have a direct influence on our body chemistry by literally limiting the molecular communication, which can have a direct influence on the delicate inter-play of hormones during the female reproductive cycle.

Despite the research around the power of relaxation, mind/body connection and addressing emotional factors to improve fertility, there is a need for a process, method and system that combines these modalities' research together and demystify it into a simple to use daily auditory regimen to allow listeners to fully engage all of these processes and improve fertility.

### SUMMARY

The invention is a process or method consisting of a new approach or regimen to improve fertility through the use of deep relaxation, mind/body guided visualization and reducing negative thought patterns through a series of auditory programs designed to be listened to on a daily basis that correspond to the female reproductive cycle. The main components of the process include unique auditory recordings, and/or audio-visual, numbering 30 in total, which will be used in a monthly regimen. The auditory regimen is designed to be used by women in the privacy of their own home, in a quiet and relaxed state. Each recording is approximately 10-18 minutes in length and uses words, music and other sounds in an optimal combination to illicit the intended goals of the regimen.

Each recording may have four main sections or steps that include (i) induction into deep relaxation using deep breathing, visualization of relaxing major body parts (progressive body scanning), suggestions to quiet thoughts, and counting down; (ii) mind/body guided visualization and focusing on what the reproductive cycle is accomplishing during that particular day of the month; (iii) addressing and releasing any emotional issues by having the listener engage in various exercises; and (iv) helping to return to normal state awareness by change in music and counting up.

Each auditory, and/or audio-visual program may be designed to correspond to the female reproductive cycle. A women's reproductive cycle is typically 28-30 days long. Within those 28-30 days, many internal systems work together within the reproductive and endocrine system to ensure healthy egg production ovulation and pregnancy. There are three main phases to the reproductive cycle: (i) follicular phase, (ii) ovulation, and (iii) luteal phase. The hypothalamus and the pituitary gland located in the brain also play a function in the reproductive cycle by providing key hormones to the ovaries in a feedback loop. The hypothalamus is also the regular of stress by secreting cortisol.

In embodiments, an audio program may be enabled to prepare a user for a guided visualization session by presenting an educational summary of the human reproductive cycle and then providing the user audio guidance in deep relaxation. The deep relaxation may be based at least in part on 1) a progressive body scan, in which the user is instructed to progressively visualize each major body part and apply a relaxation technique, 2) deep breathing instruction, and 3) instruction on the use of silencing thought techniques. The user may be provided audio-guided visualization of the human reproductive cycle in which the user is instructed to visualize each step of the cycle and visualize her body successfully completing each step of the cycle to achieve conception. Following the deep relaxation, the user may be returned to a state of normal awareness based at least in part on language cues in the audio program and changes in a music tempo within the guided visualization audio session. In embodiments, the guided visualization audio program comprises a plurality of guided visualization sessions, wherein the content of the plurality of guided visualization sessions is adapted to correspond to the events occurring within a 28-day female fertility cycle.

In embodiments, an audio-visual program may be enabled to prepare a user for a guided visualization session by presenting an educational summary of the human reproductive cycle and then providing the user audio-visual guidance in deep relaxation. The deep relaxation may be based at least in part on 1) a progressive body scan, in which the user is instructed to progressively visualize each major body part and apply a relaxation technique, 2) deep breathing instruction, and 3) instruction on the use of silencing thought techniques. The user may be provided audio-visual guided visualization of the human reproductive cycle in which the user is instructed to visualize each step of the cycle and visualize her body successfully completing each step of the cycle to achieve conception. Following the deep relaxation, the user may be returned to a state of normal awareness based at least in part on language cues in the audio-visual program and changes in a music tempo within the guided visualization audio-visual session. In embodiments, the guided visualization audio-visual program may comprise a plurality of guided visualization sessions, wherein the content of the plurality of guided visualization sessions is adapted to correspond to the events occurring within a 28-day female fertility cycle.

In embodiments, contact data for a social contact of a user may be received, wherein the contact information includes, but is not limited to, a name, a preferred form of communicating with the social contact, and a contact identifier for using the preferred form of communicating to reach the social contact. The contact data may be stored in a social contact database that is associated with a user database containing data relating to the user. An audio-visual program may be enabled to prepare a user for a guided visualization session by presenting an educational summary of the human reproductive cycle and then providing the user audio-visual guidance in deep relaxation. The deep relaxation may be based at least in part on 1) a progressive body scan, in which the user is instructed to progressively visualize each major body part and apply a relaxation technique, 2) deep breathing instruction, and 3) instruction on the use of silencing thought techniques. The user may be provided audio-visual guided visualization of the human reproductive cycle in which the user is instructed to visualize each step of the cycle and visualize her body successfully completing each step of the cycle to achieve conception. Following the deep relaxation, the user may be returned to a state of normal awareness based at least in part on language cues in the audio-visual program and changes in a music tempo within the guided visualization audio-visual session. Next, the user may be presented an interactive survey relating to fertility, wherein user completion of the survey results in a survey datum that is stored in the user database. The social contact database may then be queried to retrieve the preferred form of communicating with the social contact, and contact identifier, based at least in part on the survey datum conforming to a pre-defined value, and the contact identifier may then be used to send a message to the social contact using the preferred form of communicating with the social contact. In embodiments, the guided visualization audio-visual program may comprise a plurality of guided visualization sessions, wherein the content of the plurality of guided visualization sessions is adapted to correspond to the events occurring within a 28-day female fertility cycle.

An audio-visual program may be enabled to prepare a user for a guided visualization session by presenting an educational summary of the human reproductive cycle and then providing the user audio-visual guidance in deep relaxation. The deep relaxation may be based at least in part on 1) a progressive body scan, in which the user is instructed to progressively visualize each major body part and apply a relaxation technique, 2) deep breathing instruction, and 3) instruction on the use of silencing thought techniques. The user may be provided audio-visual guided visualization of the human reproductive cycle in which the user is instructed to visualize each step of the cycle and visualize her body successfully completing each step of the cycle to achieve conception. Following the deep relaxation, the user may be returned to a state of normal awareness based at least in part on language cues in the audio-visual program and changes in a music tempo within the guided visualization audio-visual session. Next, the user may be presented an interactive survey relating to fertility, wherein user completion of the survey results in a survey datum that is stored in the user database. The survey datum may be received by a decision engine. The decision engine may be used to select an additional audio-visual module to present to the user based at least in part on the survey datum, and the additional audio-visual module may be presented to the user. In embodiments, the guided visualization audio-visual program may comprise a plurality of guided visualization sessions, wherein the content of the plurality of guided visualization sessions is adapted to correspond to the events occurring within a 28-day female fertility cycle.

The programs may be analog or digital audio, and/or audio-visual files that can be played on a variety of listening devices such as a personal MP3 player, a computer, a CD player, DVD player, or some other type of device capable of playing an audio or audio-visual file, disk, or other recorded embodiment. The regimen may also includes two additional sessions: (i) introduction where the listener may be educated in the reproductive cycle to best prepare her for the guided visualization sessions; and (ii) a special ovulation session based at least in part upon the Law of Reversed Effort, published by the French pharmacist Emile Coue (1857-1926).

It is becoming more and more accepted that stress plays a significant role in reducing fertility issues, but the question still remains of how to implement stress reduction strategies to improve fertility for women actively trying to conceive. The process or method described herein enables women to implement stress reduction strategies to improve fertility in their daily routine. In addition, it may provide a catalyst for listeners to take control of their fertility cycles by becoming more aware of the physical processes occurring within their bodies, or soon to occur.

### BRIEF DESCRIPTION OF THE FIGURES

FIG. 1 depicts an auditory program method and system corresponding to the female reproductive system that may be used for assisting fertility patients.

FIG. 2 depicts a simplified embodiment of stages included within an auditory program method and system corresponding to the female reproductive system that may be used for assisting fertility patients.

### DETAILED DESCRIPTION

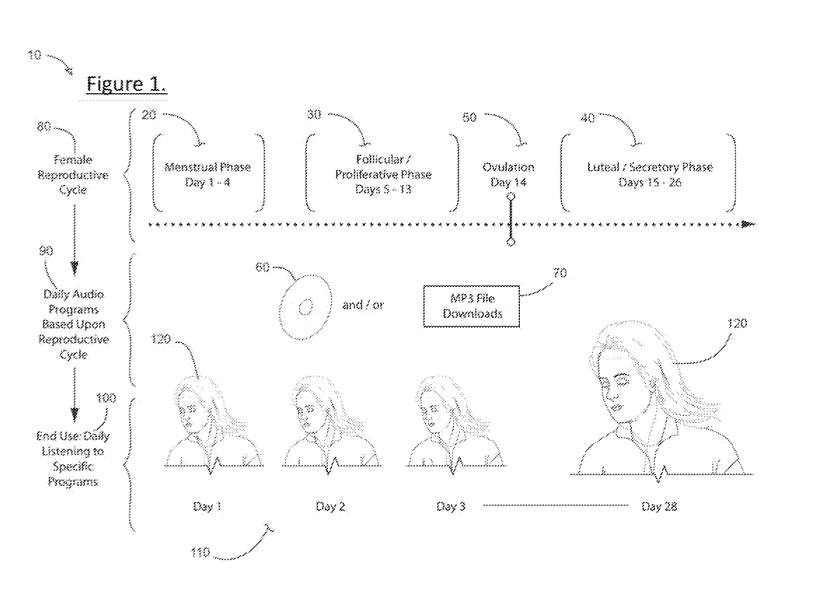

FIG. 1. depicts a method or process 10 underlying the 28-30 day auditory regimen to improve fertility where each program is unique that corresponds to the changes in the body with respect to the female reproductive cycle 80. In an example, the program may include, but is not limited to, daily auditory programs 90 designed for end use 100 by a user 120 during the menstrual phase 20, the follicular/proliferative phase 30, luteal/secretory phase, and/or ovulation 50. The program may be an auditory or audio-visual program formatted media (60, 70) for playback on, for example, an MP3 player, a computer, a CD player, DVD player, or some other type of device capable of playing an audio or audio-visual file, disk, or other recorded embodiment.

Table 1, below, describes what each daily auditory program encompasses, including (i) the changes in the reproductive system occurring during that part of the cycle; (ii) the description of the body scanning technique used during that program; (iii) the cognitive emotional exercise; (iv) the length of each program; and (v) the title of the music underlying each program. In addition, descriptions of both the program introduction and the special ovulation session are included in the table.

TABLE 1

| Program | Description | Relaxation Session | Music |
|---|---|---|---|
| Program | Description of the hypothalamus, | N/A | N/A |
| Introduction | pituitary, ovaries, uterus and the | | |
| 9.46 | hormones that play a central role in | | |
| | the reproductive cycle. | | |
| | Overview of the stress and fertility | | |
| | link | | |
| | Discussion of the mind/body | | |
| | connection | | |
| | Overview of how to best use the | | |
| | program (i.e., listening in a quiet | | |
| | place where they will not be | | |
| | disturbed, etc.) and when to start the | | |
| | programs (Day 1 corresponding to | | |
| | the beginning of the cycle). | | |
| | Having a positive attitude going into | | |
| | starting the program. | | |
| | Recommended other ways to | | |
| | augment the program such as | | |
| | journaling, etc. | | |
| Day One | Visualization of hypothalamus and | Deep breathing | “Dreamscape” |
| 17.17 min. | reduction of stress. | Picturing | |
| | Shedding of uterus lining in | relaxation energy | |
| | preparation for new month | touching all | |
| | (cleansing). | major body parts | |
| | Guided visualization of journey to a | Counting down | |
| | special place of their choosing. | from 25 | |
| | Allow user to become comfortable | | |
| | and establish a visual representation | | |
| | of their mind/body connection. | | |
| Day Two | Visualization of hypothalamus and | Deep breathing | “Zen Zen” |
| 16.13 min. | pituitary, relaxation energy | Imagining major | |
| | surrounding both. | body parts and | |
| | Communication of hypothalamus and | allowing for each | |
| | pituitary (representing white pearly | part to relax fully | |
| | lights) | Counting down | |
| | Establishing visual (again) of mind/ | from 25 | |
| | body connection | | |
| | Shedding of excess negative energy | | |
| | through out-breath. | | |
| Day Three | Continued visualization to allow | Deep breathing | “Silent Lake” |
| 14.42 min. | shedding of negative energy with the | Picturing warm | Sounds of water |
| | hypothalamus and pituitary gland. | blanket covering | and birds when |
| | Increased flow of GNRH from | body to induce | journeying to |
| | hypothalamus to the pituitary. | full relaxation | special place |
| | Journey to special place with bridge | Counting down | |
| | as metaphor for mind-body | from 25 | |
| | connection. | | |
| Day Four | Visualizing the ovaries | Deep breathing | April Sky |
| 16.34 | The circle of communication between | Picturing | Sounds of water |
| | the hypothalamus and pituitary with | relaxation energy | and birds when |
| | the ovaries happening with just the | touching all | visualizing a |
| | right amount of hormones at exactly | major body parts | special place |
| | the right time - building daily with | Counting down | |
| | GNRH | from 25 | |
| | Allowing to journey to special place | | |
| | for deep relaxation | | |
| Day Five | Picturing relaxation spreading all | Deep breathing | “Dreamscape” |
| 15.32 | throughout reproductive organs. | Imagining body | Sounds of water |
| | Focusing on the circle of | parts in deep | and birds when |
| | communication between ovaries and | relaxation | visualizing |
| | hypothalamus and the pituitary where | Counting down | special place |
| | LH and FSH (hormones) | from 25 | |
| | communicate between the pituitary | | |
| | and the ovaries. | | |
| | Visualize outcome user desires by | | |
| | seeing mirror image and becoming | | |
| | that image in the mirror | | |
| Day Six | Continued visualization of | Deep breathing | “Zen-Zen” |
| 16.04 | hypothalamus and pituitary gland and | Picturing blanket | |
| | the “talking” with the ovaries. | covering entire | |
| | Starting to picturing developing | body | |
| | follicle within the ovaries. | Counting down | |
| | Fallopian tubes are also “passable” | from 10 | |
| | and open | | |
| | Journey to place for “mini-vacation” | | |
| | Emotional exercise: visualizing | | |
| | loved ones and the relative influence | | |
| | (stress) either strengthened or | | |
| | weakened, depending on the desire | | |
| Day Seven | Seeing harmony and effects of | Deep breathing | “Silent Lake” |
| 16.06 | relaxation all throughout. | Picturing | |
| | Allowing negative energy to dissipate | relaxation energy | |
| | and not affect the reproductive cycle. | touching all | |
| | Visualization of uterus and the | major body parts | |
| | beginning phases of preparing for | Counting down | |
| | fertilized egg. | from 10 | |
| | Planting magic seeds in perfectly | | |
| | fertile soil that sprout into beautiful | | |
| | roses. | | |
| | Positive energy on hands; laying of | | |
| | hands on lower abdomen over | | |
| | reproductive organs | | |
| Day Eight | Abundance of follicles - or future | Deep breathing | “Dreamscape |
| 15.20 | eggs - in ovaries and how the ovaries | Picturing body | |
| | are building up one special egg for | parts in large | |
| | ovulation. | areas and | |
| | Imagining the act of writing in a | focusing on | |
| | journal - positive and negative | relaxation | |
| | thoughts and then throwing the pages | Counting down | |
| | in a small bonfire that allows for | from 10 | |
| | either the negative emotions to | | |
| | dissipate, or to strengthen the positive | | |
| | ones. | | |
| Day Nine | Picturing the perfect development of | Focus on blanket | “Silent Lake” |
| 17.44 | an egg and the preparation of the | laying over the | |
| | uterus. | entire body | |
| | Allowing you comparison against | providing full | |
| | beautiful mighty oak tree. | relaxation | |
| | Seeing yourself in mirror in ways that | Deep breathing | |
| | you want to transpire, and then | Counting down | |
| | merging with that image. | from 10 | |
| Day Ten | Picturing the act of ridding body of | Deep breathing | “Zen Zen” |
| 16.30 | anything that doesn't belong there - | Imagining major | |
| | allowing for perfect development of | body parts and | |
| | everything inside. | allowing for each | |
| | Imagining mirror picturing the | part to relax fully | |
| | outcome of desire. | Counting down | |
| | Picturing rainbow representing | from 10 | |
| | abundance - rainbow passing through | | |
| | the physical body depositing mini- | | |
| | rainbows in all of the cells | | |
| Day Eleven | Focus on the developing egg that | Focus on each | “April Sky” |
| 16.12 | grows strong - really picturing it in | body part with | |
| | terms of size, color, etc. Focus on | relaxation in | |
| | balance, etc. | mind. | |
| | Picturing and knowing that hormones | | |
| | are passing through as just the right | | |
| | time and speed and ovary are gearing | | |
| | up to release egg. | | |
| | Visualizing dancing with partner - | | |
| | releasing any negative emotions that | | |
| | may be impacting relationship | | |
| Day Twelve | Confirming that the hypothalamus | Deep breathing | “Silent Lake” |
| 16.04 | and pituitary gland are operating as | Picturing | |
| | they should. | relaxation energy | |
| | Surge of LH hormone in anticipation | touching all | |
| | of release of egg to fallopian tube. | major body parts | |
| | Full and completely health ovum. | Counting down | |
| | Picturing union of love between | from 25 | |
| | yourself and partner. | | |
| | Experiencing sitting on bench in | | |
| | garden with loved one with full moon | | |
| | and stars in crystal clear night sky. | | |
| Day Thirteen | Really allowing for full relaxation as | Deep breathing | “Zen Zen” |
| 14.39 | there is hormone surge and gearing | Imagining major | |
| | up to release healthy ovum. | body parts and | |
| | Seeing the right amount of cervical | allowing for each | |
| | mucus to allow for the acceptance | part to relax fully | |
| | and passibility of partner's sperm. | Counting down | |
| | Experiencing the building of your | from 10 | |
| | dream house as metaphor - “control” | | |
| | room in the house that you control all | | |
| | hormones and your mind tells you | | |
| | where those levers need to be placed. | | |
| | Cervical mucus is included. | | |
| Day Fourteen | Visualization exercise of the release | Deep breathing | “April Sky” |
| 15.58 | of egg into fallopian tube. Really | Picturing warm | |
| | picturing the color, the weight, it's | blanket covering | |
| | movement. Starting to visualize the | body to induce | |
| | union with sperm. | full relaxation | |
| | Metaphor visualization of bird | Counting down | |
| | building nest, laying an egg and | from 10 | |
| | keeping it warm through nurturance. | | |
| Day Fifteen | Focus on ovulation, release of the | Deep breathing | “Dreamscape” |
| 14.58 | egg, relaxation of the cervix, | Imagining major | |
| | movement of the sperm. | body parts and | |
| | Abundance of time. | allowing for each | |
| | Relaxation of the entire abdomen | part to relax fully | |
| | area. | Counting down | |
| | Metaphor visualization of creativity. | from 25 | |
| Day Sixteen | Life-force that has been created - | Deep breathing | “Zen Zen” |
| 14.51 | visualization of what it looks like, | Picturing | |
| | where it is, how it grows and how it | relaxation energy | |
| | moves. | touching all | |
| | Uterus development with | major body parts | |
| | progesterone building from corpus | Counting down | |
| | luteum. | from 10 | |
| | Expressing creativity through specific | | |
| | ways as metaphor for the creative | | |
| | process of the sperm and egg. | | |
| Day Seventeen | Continued visualization of the sperm | Deep breathing | “April Sky” |
| 16.02 | and egg union - the growth and tiny | Picturing warm | |
| | movement of the fertilized egg. | blanket covering | |
| | The balanced hormones - particular | body to induce | |
| | progesterone - in helping ready the | full relaxation | |
| | uterus for implantation. | Counting down | |
| | Comparing uterus to nest. | from 10 | |
| | Expressing creativity as metaphor as | | |
| | Day Sixteen. | | |
| Day Eighteen | Continued visualization of the sperm | Deep breathing | “Dreamscape” |
| 14.54 | and egg union - the growth and tiny | Imagining body | |
| | movement of the fertilized egg. | parts in deep | |
| | The balanced hormones - particular | relaxation | |
| | progesterone - in helping ready the | Counting down | |
| | uterus for implantation. | from 10 | |
| | Visualization of water as metaphor | | |
| | for life, balance and harmony. | | |
| Day Nineteen | Tiny life-force energy that is growing | Deep breathing | “Silent Lake” |
| 14.36 | at just the right speed and moving at | Imagining body | |
| | just the right amount toward the | parts in deep | |
| | uterus. | relaxation | |
| | Progesterone hormone | Counting down | |
| | communication between the ovaries | from 10 | |
| | and the uterus happening in perfect | | |
| | balance. | | |
| | Gifts of abundance in mini-vacation. | | |
| | Relaxation in perfect spot in universe. | | |
| Day Twenty | Continued focus on the fertilized egg | Deep breathing | “Zen Zen” |
| 13.46 | growth and movement and | Imagining | |
| | progesterone building. | relaxing in warm | |
| | Uterus developing - use of “nest” as | water bath | |
| | metaphor. | Counting down | |
| | Journey back to the dream house that | from 10 | |
| | you built. | | |
| | Visiting the “control room” where the | | |
| | lever for progesterone is at the exact | | |
| | right position. | | |
| Day Twenty-One | Continued focus on the mini “life | Deep breathing | “Dreamscape” |
| 15.26 | force” traveling to the uterus, getting | Imagining major | |
| | ready for implantation | body parts and | |
| | Uterus building up cushion of | allowing for each | |
| | “warmth” that will provide for the | part to relax fully | |
| | fertilized egg. | Counting down | |
| | Visualization of giving something of | from 10 | |
| | value to a person truly in need. | | |
| | Feeling what it means to give and | | |
| | therefore receive. | | |
| Day Twenty-Two | Focus is on the movement of the | Deep breathing | “Silent Lake” |
| 16.02 | fertilized egg into the uterus at just | Imagining body | Sounds of water |
| | the right time. | parts in deep | and birds when |
| | Implantation of the egg in the uterus | relaxation | journeying to |
| | with the just the right amount of | Counting down | special place |
| | cushion, nutrients, blood - and | from 25 | |
| | progesterone from corpus luteum | | |
| | Journey to your dream house where | | |
| | you give yourself a special treat. | | |
| Day Twenty-Three | Visualizing the inside of the uterus | Deep breathing | “Zen Zen” |
| 14.18 | and seeing the egg either already | Imagining | |
| | implanted, or going to be implanted. | relaxing in warm | |
| | Expressions of gratitude to yourself | water bath | |
| | and the positive energy that | Counting down | |
| | surrounds you and has become a part | from 10 | |
| | of you. | | |
| | Mother Earth as metaphor for this | | |
| | positive energy. | | |
| Day Twenty-Four | Visualization of implanted egg and | Deep breathing | “Silent Lake” |
| 15.44 | the hormones that are now beginning | Picturing | |
| | to come from the implanted egg. | relaxation energy | |
| | The uterus is visualized as full of | touching all | |
| | “cushion, warmth and love” | major body parts | |
| | Feeling a tiny vibration from the tiny | Counting down | |
| | life-force after sending waves of | from 10 | |
| | relaxation energy. | | |
| | House that you have built as | | |
| | metaphor. Finding “control” room | | |
| | and adjusting levers as needed. | | |
| Day Twenty-Five | Visualization of implanted egg and | Deep breathing | “April Sky” |
| 16.04 | the hormones that are now beginning | Picturing warm | |
| | to come from the implanted egg. | blanket covering | |
| | Egg is growing more and more | body to induce | |
| | complex everyday. Tiny vibration is | full relaxation | |
| | felt again. | Counting down | |
| | Expressing creativity through | from 10 | |
| | whatever form feels right to the user. | | |
| Day Twenty-Six | Visualization of implanted egg and | Deep breathing | “Dreamscape” |
| 15.26 | the hormones that are now beginning | Picturing body | |
| | to come from the implanted egg. | parts in large | |
| | Uterus producing the right and | areas and | |
| | balanced flow of blood, nutrients and | focusing on | |
| | hormones to successfully help grow | relaxation | |
| | the fertilized egg. | Counting down | |
| | Journey to a path that represents the | from 10 | |
| | future. Courage to follow the path | | |
| | even with ups and downs. Foreign | | |
| | country with orphanage where you | | |
| | help all of the occupants inside. | | |
| Day Twenty-Seven | Visualization of implanted egg and | Deep breathing | “Zen Zen” |
| 14.25 | the hormones that are now beginning | Imagining | |
| | to come from the implanted egg. | relaxing in warm | |
| | Uterus has been full and heavy. See | water bath | |
| | roundness and really feeling the | Counting down | |
| | positive energy radiating from inside. | from 10 | |
| | Expression of gratitude. Giving | | |
| | prized possessions to people in need. | | |
| Day Twenty-Eight | Visualization of implanted egg and | Deep breathing | “Silent Lake” |
| 15.02 | the hormones that are now beginning | Picturing | |
| | to come from the implanted egg. | relaxation energy | |
| | Taking a pregnancy test | touching all | |
| | Visualize what you will look like | major body parts | |
| | pregnant. Feeling of fullness, being | Counting down | |
| | fully alive and living in the present | from 10 | |
| | moment. | | |
| Special Ovulation | Based upon the Law of Reversed | Deep breathing | “Zen Zen” |
| Session | Effort (M. Coue) where the harder we | Imagining | |
| | put our conscious will towards | relaxing in warm | |
| | something, the harder it is to obtain | water bath | |
| | our desire. For example, when we | Counting down | |
| | want to fall asleep and try very hard | from 10 | |
| | to fall asleep, the chance of sleep | | |
| | diminishes greatly. | | |
| | Based upon this, we have developed | | |
| | the special ovulation session to | | |
| | imagine a time when the listener | | |
| | would NOT have wanted to become | | |
| | pregnant and they seek to commit the | | |
| | act of sexual intercourse for pleasure | | |
| | but clearly not wanting to become | | |
| | pregnant. | | |
| | This is an attempt to engage the | | |
| | user's imagination to reverse the | | |
| | effort - to allow the body to | | |
| | accomplish what it can without any | | |
| | will of the mind. | | |

In an example embodiment of the present invention, a woman may listen to the pre-cycle sessions to get her emotions ready to begin a medicated cycle. They could then listen to a Day 1 and 2 cycle audio focusing on a healthy acceptance of synthetic hormones, welcoming the hormones as part of the exercise for optimum effectiveness and visualizing the required communication between the hypothalamus-pituitary. According the methods and systems of the present invention, sessions may be provided for each step of the fertility treatment process leading up to receiving a trigger shot and experiencing egg extraction. Further, specific audio sessions may be provided via a mobile device, such as an Ipod or some other mp3 player, while a doctor is actually performing a procedure. Additional sessions, such as Cycle 13+14 may enable detailed medical visualizations to focus on uterus preparation to accept fertilized eggs, with, in an example, special focus on progesterone, and the like. Additional audio programs may be provided to the patient to listen to while a procedure is being performed in order to help make the egg transfer more effective. In embodiments, the medical visualizations may focus on seeing proper blood-oxygen circulation inside the uterus, the embryo coming into the uterus, and the embryo coming inside and being accepted. Sessions may be specifically designed for the patient to use during the typical two-week wait period when the patient must wait to find out if the procedure was successful. In embodiments, sessions may include a focus on having feelings of gratitude and abundance, attention to what is happening inside uterus, hormones moving in just the right amounts at the right time, warmth and acceptance on a cellular basis, or some other type of targeting visualization.

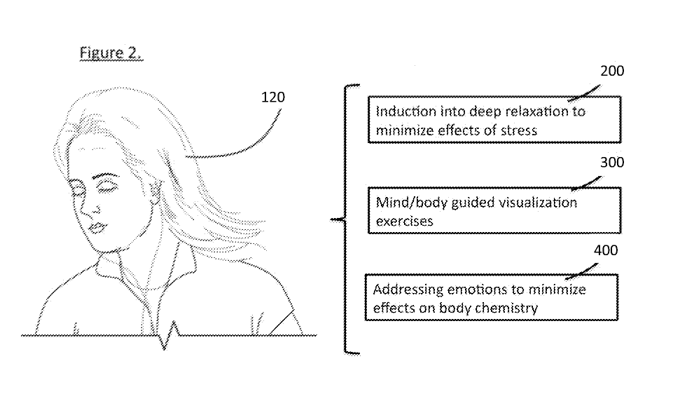

FIG. 2. depicts processes that each program may contain for a user's 120 audio session, for example, three cognitive modalities to help improve fertility. Each program follows a progression starting with (i) induction into deep relaxation 200; (ii) guided visualization to enlist the mind/body connection 300; (iii) addressing emotions involved in trying to conceive 400; and (iv) a return to normal awareness. Each of these elements are further discussed as follows:

Step 1. Induction into Deep Relaxation. The beginning part of the program is all about quieting the mind and relaxing each body part and entering into deep relaxation where the user's body will feel very weighted, heavy and go very quiet after this section. This will help reverse the effects of stress and prepare the listener for the guided visualization exercises. The program accomplishes this through a variety of methods including:

Progressive body scan—walking the listener through a visualization process of each major body part with relaxation in mind. There are a variety of types of visualization processes used such as imagining an energy field that touches on each major body part, a blanket that covers the entire body and instantly relaxes the body, or entering a warm body of water that soothes, warms and settles the body;

Deep breathing—the programs guide the user to slow the breath and breathe deep, expanding the abdomen cavity whereby the inhale brings in positive energy and the exhale expels any negative or excess energy, stress or anxiety; and

Silencing thoughts—suggestions to the user to try to silence her thoughts during the program to be able to focus on the words and the music of the programs. The thoughts that may come during the session are suggested to be put to the side to return after the session is completed.

Step 2. Guided Visualization to Engage the Mind/Body Connection. After the listener is in a deeply relaxed state in both mind and body, the programs then help to connect the mind and body through guided visualization. The introduction session provides a baseline understanding of the reproductive cycle to help the user best visualize the intended balancing, changing or other aspects of what the reproductive system should be doing at this time. This section of the program creates a connection between the mind and body, having the mind instruct the body on how it should be performing. This is process will help promote balance, healing and restoration to a person's natural state.

The program tracks in detail the listener's menstrual/ovulation cycle, which is important to fully unlock the power of mind-body science. Table 1. describes the focus for each day from a guided visualization perspective. Everyday, women's hormones are interacting with one another, changing and causing change within their ovaries and uterus in multiple feedback loops. The program utilizes various mind/body methods to create detailed physiological based imagery including visualization exercises of the hypothalamus, pituitary gland, ovaries, fallopian tubes, uterus, cervix, etc. and the optimal state of each process happening during that unique part of the reproductive cycle. The visualization follows the hormone loop and how they interact with one another, change and cause change in the ovaries, uterus, egg development, implantation, etc. on a daily basis. The education centers on the brain, ovaries and uterus to best prepare the user for guided visualization exercises to best engage the mind/body communication. This detail increases the power of the mind/body self-healing ability, promotes balance, healing and restoration to our natural state.

Step 3. Addressing Emotions Involved in Trying to Conceive. This step provides a task or visualization exercise that might help address any anxiety or other negative emotions that may have an impact on the listener's body chemistry. Allowing ones imagination to proactively manage things that it needs to address can be very empowering. The exercises intend to illicit the broad and very personal experiences or emotions that may be at play with each individual. Example of exercises/tasks include:

Free writing of negative feelings that come to mind on a piece of paper and then burying, burning or destroying that piece of paper;

Imagining the strengthening or weakening of the effects of loved ones that may be helping or hindering fertility;

Choosing a person or persons in need and helping them in whatever way they can and feeling the gratitude in return;

Imagining a garden growing and then selecting the one flower that represents the listener and then melding with that flower for feelings of optimism, beauty and confidence; and

Others as illustrated in Table 1.

The program is not specific with types of emotions, rather, it intends to illicit confrontation of those emotions that are particular to that person. Examples of negative emotions that may be held consciously or unconsciously could be:

Anxiety concerning becoming a parent and all of the responsibilities associated with it;

Painful childhood memories that may be impeding one's fertility or true desire for pregnancy;

Painful past experiences with pregnancies (miscarriages, abortions);

Fear of medical treatments they have had or might need to have to help with fertility; and

Other situations that would be very specific to the individual and could range broadly.

Step 4. Returning to Normal Awareness. Lastly, the program provides the means for the listener to come back to full awareness allowing them to feel fully restored, refreshed and ready for the rest of the day or night. This is done by a combination of some or all of the following:

Counting up and in combination with words such as “awakening,” “feeling refreshed,” etc.; and

Transitioning the music to be more upbeat with a faster tempo.

The regimen is applicable for all women seeking conception ranging from those who may be just starting to get pregnant to those diagnosed with either unexplained infertility or an infertility medical-based problem such Polycystic Ovarian Syndrome (“PCOS”), Endometriosis, ovarian cysts, and all types of other diagnoses. In fact, the program could be further customized with specific guided visualizations to assist women with specific fertility treatments, diagnoses, etc., such as:

Intrauterine insemination (“IUI”);

In vitro fertilization (“IVF”);

Other assisted reproduction technologies;

PCOS;

Ovarian Hyperstimulation Syndrome;

Endometrosis;

Ovarian cysts; and

Any other fertility diagnoses.

The regimen may also extend and include first trimester, second trimester and third trimester pregnancy programs. The program may also include a modified version of the program for women who are just starting to get pregnant.

Depending on the state of the listener's fertility situation, the program may either be used as a sole fertility aid, or in combination with other fertility treatments under the guidance of a medical professional or using other fertility relaxation aids such as yoga, acupuncture, deep breathing exercises, hypnosis, group therapy, etc.

The program may also be used in a spoken person-to-person form. This may include practitioners who have been instructed through a train-the-trainer type modality. This may include music playing as background. The programs may also be used in a group setting, similar to a yoga session, group therapy session, or something similar.

The program may include customizations at the individual level who may wish to have a specific visualization included in the programs, unique music, or any other combination thereof.

Each program uses a combination of music and words to optimally induce relaxation that (i) reduces the harmful effects of stress; and (ii) optimally prepares the user to open subconscious awareness to engage the mind/body connection.

The program is designed for ease-of-use and integration into the user's daily routine, providing optimal and repetitive use of relaxation to continuously reduce the effects of stress. It is difficult on one's own to have either the know-how to induce such deep relaxation and engagement of the mind/body connection. The program demystifies these questions.

This process or method utilizing the combination of relaxation, mind/body visualizations that track to the underlying medical situation and addressing negative emotions may be used in a variety of other health-related situations such as:

Back pain;

Body weight issues;

Cancer and pain management through the treatment process;

High blood pressure;

Asthma;

Gastrointestinal disorders; and

and others.

Other embodiments of the product include enabling the technology used for the product to create various extensions including:

On-line Community—An on-line community for the users will enhance the positive impact of daily use of the product. Through online web-based forums, chat-rooms, blogs, video-chatting, emailing, etc. users would become part of an online community. The ability to connect with other users of the program will significantly improve the user's experience by sharing with others their thoughts, questions and emotions. The community is a strong support group for women who are going through the conception process. The database of users will be robust and allow the ability to match users to useful sub-groups within the community. It will also help to link women to industry experts to help with specific issues they are facing.

Social Networking—The vast array of social networking platforms will allow daily communication with the user in an efficient and effective manner. It may offer opportunities to add onto the regimen, for example a thought of the day, additional exercises they could consider, keep them up to date on research, link them to industry expert blogs, recent articles. It will also allow users to communicate easily on a wide array of platforms with other users and medical fertility experts.

Streaming of the product—The program may be delivered directly on mobile applications and hand-held devices through streaming or other future technology. This will create the ultimate in portability and access anytime to the programs. The programs may be offered directly on mobile devices through custom-designed mobile applications.

Personalizing the regimen—The program may include the ability to customize according to user's preferences for the types of programs to engage with. For example, there may be a decision tree that user is stepped through and depending on answers at each node of the tree a software program may automatically choose the right kind of program for that particular user. The variables of the program may include variations on music (or sounds instead of music such as running water, ocean, etc), visualization exercises (a person might want visualize being on mountain or swimming in a river), relaxation, emotional exercises, etc. The software program may allow for analytics to evaluate the importance of each variable and new variables to add on.

Environmental variables—There are many environmental variables that impact fertility such as amount of sunlight. Technology will allow a series of questions to be asked around the environment the user is in and tailor the program to the specifics of that environment. For example if the location of the user has not received sunlight for 4 days then the program may indicate that as part of the program the user should go to a tanning bed to get the benefits that sunlight brings to fertility.

Physical variables—Technology may allow for devices that would monitor physical conditions of the user and feed that into a software program to allow the program to be tailored to the specifics of the users vitals, ovulation status and other medical statistics.

All of these extensions will create and continue to build on a meta data base that will not only strengthen the extended offerings noted above, but will create new extensions of the offering. The meta database may allow for a high degree of analytics that will give insight into the effectiveness of different approaches for all different types of women, environmental factors, and physical factors.

In embodiments, the methods and systems of the present invention described herein may be combined with, but not limited to, the following embodiments:
Online journaling
Audio and/or audio visual journaling, including but not limited to journaling on a smart phone (e.g., and Iphone)
Incorporation of images for patient viewing (e.g., on an Ipod, or Ipad) while listening to the audio program(s)
Personalization of the audio program (e.g., types of images used, names)
Listening to the audio program(s) on a mobile device, such as a smart phone (e.g., the Iphone)
Receiving the audio program as part of a smart phone application, where the application may be synchronized to correspond to the days within the human reproductive cycle, and where the application may receive new content for use by the user, such as inspirational quotes or some other type of content
Accessing the audio program(s) through a subscription based service

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. An audio product embodied in an audio-playable medium that, when executing on one or more audio devices, performs the steps of:
preparing a user for a guided visualization audio session by presenting an educational summary of the human reproductive cycle;
providing the user audio guidance in deep relaxation, wherein the deep relaxation is based at least in part on 1) a progressive body scan, in which the user is instructed to progressively visualize each major body part and apply a relaxation technique, 2) deep breathing instruction, and 3) instruction on the use of silencing thought techniques;
providing the user audio guided visualization of the human reproductive cycle in which the user is instructed to visualize each step of the cycle and visualize her body successfully completing each step of the cycle to achieve conception; and
returning the user to a state of normal awareness based at least in part on language cues and changes in a music tempo within the guided visualization audio session.

2. The audio product of claim 1, wherein the guided visualization of the human reproductive cycle comprises a plurality of guided visualization sessions, wherein the content of the plurality of guided visualization sessions is adapted to correspond to the events occurring within a 28-day female fertility cycle.

3. The audio product of claim 1, where the educational summary of the human reproductive cycle includes explanation and guided visualization of communication between the hypothalamus, pituitary, and ovaries.

4. The audio product of claim 1, where the educational summary of the human reproductive cycle includes explanation and guided visualization of the hormonal communication between pituitary and ovary.

5. The audio product of claim 1, wherein the audio guided visualization includes visualization of uterine phases preceding human conception.

6. The audio product of claim 1, wherein the audio guided visualization includes visualization of follicle development.

7. The audio product of claim 1, wherein the audio guided visualization includes visualization of human egg development and corresponding hormonal interaction necessary for human conception.

8. The audio product of claim 1, wherein the audio guided visualization includes visualization of an LH hormonal surge corresponding to successful human egg release.

9. The audio product of claim 1, wherein the audio guided visualization includes visualization of human egg release and interaction of released human egg with human sperm.

10. The audio product of claim 1, wherein the audio guided visualization includes visualization of a successfully fertilized human egg.

11. The audio product of claim 1, wherein the audio guided visualization includes visualization of hormonal balance of progesterone level.

12. The audio product of claim 1, wherein the audio guided visualization includes visualization of a developing embryo.

13. The audio product of claim 1, wherein the audio product is delivered to a user on a mobile device that is enabled to playback audio content.

14. The audio product of claim 1, wherein the mobile device is a mobile phone.

15. The audio product of claim 1, wherein the audio product is delivered to a user within an application operating on a mobile phone.

16. A computer program product embodied in a computer readable medium that, when executing on one or more computers, performs the steps of:
providing a user an audio-visual depiction of the human reproductive cycle;
providing the user an audio-visual program guiding the user in deep relaxation, wherein the deep relaxation is based at least in part on 1) a progressive body scan, in which the user is instructed to progressively visualize each major body part and apply a relaxation technique, 2) deep breathing instruction, and 3) instruction on the use of silencing thought techniques;
providing the user an audio-visual program for guided visualization of the human reproductive cycle in which the user is instructed to visualize each step of the cycle and visualize her body successfully completing each step of the cycle to achieve conception; and
returning the user to a state of normal awareness based at least in part on audio-visual cues and changes in a music tempo within the guided visualization audio session.

17. The computer program product of claim 2, wherein the guided visualization of the human reproductive cycle comprises a plurality of guided visualization sessions, wherein the content of the plurality of guided visualization sessions is adapted to correspond to the events occurring within a 28-day female fertility cycle.

18. A computer program product embodied in a computer readable medium that, when executing on one or more computers, performs the steps of:
providing a user an audio-visual depiction of the human reproductive cycle;
providing the user an audio-visual program guiding the user in deep relaxation, wherein the deep relaxation is based at least in part on 1) a progressive body scan, in which the user is instructed to progressively visualize each major body part and apply a relaxation technique, 2) deep breathing instruction, and 3) instructing the user to use silencing thought techniques;
providing the user an audio-visual program for guided visualization of the human reproductive cycle in which the user is instructed to visualize each step of the cycle and visualize her body successfully completing each step of the cycle to achieve conception;
returning the user to a state of normal awareness based at least in part on audio-visual cues and changes in a music tempo within the guided visualization audio session;
presenting the user an interactive survey relating to fertility, wherein user completion of the survey results in a survey datum that is stored in the user database;
receiving the survey datum at a decision engine;
using the decision engine to select an additional audio-visual module to present to the user based at least in part on the survey datum; and
presenting the additional audio-visual module to the user.

19. Further comprising the computer program product of claim 4, wherein the guided visualization of the human reproductive cycle comprises 28 guided visualization sessions, wherein the content of each of the 28 sessions substantively corresponds to the events occurring within a 28-day female fertility cycle.

20. The computer program product of claim 18, wherein the audio-visual depiction is delivered to a user within an application operating on a mobile phone.
